(19) United States
(12) Patent Application Publication
(10) Pub. No.: US 2006/0036695 A1
(43) Pub. Date: Feb. 16, 2006

(54) Timed delivery of alert notifications based on user set criteria

(76) Inventor: Robert Christopher Rolnik, Southlake, TX (US)

Correspondence Address: Robert C. Rolnik, 1208 Normandy Dr., Southlake, TX, 76092, US

(21) Appl. No.: 10/917,113

(22) Filed: Aug. 12, 2004

(51) Int. Cl. G06F 15/16

(52) U.S. Cl. 709/206

(57) ABSTRACT

An apparatus to receive a message (351) and detect if a delay should be applied (353). If so, delay (355) so that for each received message, at least a delay occurs between dispatch of a set of discrete message(s). Detecting a first priority class message (361) results in sending a first discrete message (367) and a second discrete message (369). However, failing to detect a first priority class message results in setting delay flag (363) and sending at least one discrete message (365).

### FIELD OF INVENTION

The present invention relates generally to the field of electronic messaging, and more specifically to the field of transmitting alerts to generally low-powered, limited user interface thin clients.

### BACKGROUND

The Personal Communications Industry Association (PCIA), formerly known as Telocator, is the governing body which administers paging protocols which are developed within its technical committees. Before the inception of Telocator, paging systems were only able to dispatch wirelessly the telephone number that an intended pager recipient was to call. An innovation beyond that called the Telocator Alphanumeric Protocol (TAP) in the 1980s permitted messages to pagers to include alphabetical characters, and greatly expanded the data payload carrying capacity of a page.

Recently a more advanced protocol has been standardized by the PCIA, the Telocator Data Protocol (TDP). TDP was developed as a next generation of the TAP protocol. With TDP, subscribers now have the option of either receiving the message directly at the pager or having it forwarded to a mailbox for later retrieval with a spawned short notification message being sent to the pager in near real time. The Short Message Service is a 1990's era wireless messaging format established by the Global System for Mobiles (GSM) standardization body as an adjunct to cellular voice telephony. The idea for SMS was mainly to permit two subscribers on one or more GSM networks to exchange alphanumeric messages of up to 160 characters. Many wireless carriers have added an email gateway to permit inbound and outbound emails to interface to the limited SMS function.

The SMS Centers (SMSC) operate to route SMS within and between GSM-type networks. Such systems are store and forward servers. I.e. they receive a message, and forward it when the subscriber or system resources are available. All short messages have a message lifetime—those short messages that do not have a specific value when submitted are automatically assigned the default Validity Period for that mobile network. For example, some mobile network operators set a maximum short message lifetime of 72 hours (Vodafone, UK) or 48 hours (Vodafone D2, Germany), after which any short messages that haven't been delivered are deleted. Recently SMSCs have been enabled to provide interconnectivity from internet applications to mobile telephones, e.g. the SMSC may now receive an email address corresponding to a mobile phone, and then provide portions of the email to the mobile in the native SMS format.

Though the SMS protocols have been flexible enough to transport application (layer) messages that extend beyond the 160 character limit, as well as transport Wireless Application Protocol (WAP) data, ringtone data as well as several other application data, the SMS is limited in that it cannot change the manner with which the mobile station alerts or notifies the user of the received message. In other words, the mobile station will either play (or in some cases vibrate) the default alert, or, where customized by the user, play the customized alert (sometimes established in a device profile).

Though the SMS protocol is quite advanced, and provides for at least immediate display of text to a terminal (once received), it offers nothing to the sender in the way of selecting the type of alert (loudness, pitch, vibration). Nevertheless, some mobile phone manufacturers have allowed for users of the phones to personalize the look and feel of the mobile phone by, e.g. selecting the loudness and type of alert the phone will make for all received messages. This does not permit the mobile phone to alert specially for any special class of message however.

Enhanced Messaging Service attempted to build on the basic SMS framework of the early 1990s and it, through its extensions permitted transmittal of many other application forms, including vCalendars, vCards, Vector graphics and much more—chiefly by treating the SMS as yet another packet transport, and re-assembling many packets/SMS that arrive reasonably contemporaneously. As such, both EMS and proprietary protocols of some manufacturers, attempted to take trains of SMS that arrive at their mobile devices, and collectivize such trains into a cohesive whole. Thus, when a sequence of such SMS either began to arrive, or substantially completed arrival, a single tone or alert would occur on the handset. EMS did not provide for timing of received messages or converting a single message into two or more discrete messages and their attendant tones. Nor would EMS present a single EMS as multiple messages on a handset display.

On the voice side of technology, it has been fairly routine to implement a Caller Identification (CID) to signal the identity and often the type of caller who is calling a phone. Because of the ability to establish specific ring tones for particular callers, it is now easier to avoid bill-collectors, mothers-in-law, and anyone else deemed an annoyance. Nevertheless, such calls are real-time, and the choice made, at that time is to answer the call or not. In contrast, email and other electronic notifications provoke a choice of when to reply and react to the message, rather than a choice if the message requires immediate attention. Also, the use of CID does not permit an owner to establish criteria from a message content to determine the manner of any alert made on the handset.

U.S. Pat. No. 6,185,603, Henderson, describes a system to receive email and maps pager numbers and codes to email recipients. That invention permits messages of varying priority to be displayed in varying fonts. While working at the user's PC (with a client application active) the user will hear a short audio alert tone and then see the message below in the IMP window. Henderson provides for a background color of a window to change when an alert is received. The email itself, if intended to reach a pager, must include an IMP paging directive in the subject.

U.S. Pat. No. 6,711,154, O'Neal, describes message format as follows: user designates, either from a computer, or from a telephone, the types of messages for which s/he wishes to be alerted, and designates one or more device types (email address, fax machine, pager number, or telephone number) to receive the alert. O'Neal does not permit a sender to influence the device upon which an alert will arrive. O'Neal does not differentiate messages received with a particular temporal alert to indicate the type of message received or content.

U.S. Pat. No. 6,643,684, Malkin, shows a means or associating sender specified policies with a particular communication for delivery of content to one or more said receiving devices; receiving from a sending device the sender-specified policies associated with the particular communication for delivery of content to the one or more said receiving devices, wherein at least one of said receiving devices is distinct from the sending device; and breaking the transmissions into component parts. Malkin does not specify that the sender may add a pairing of alerts or permit the receiver to filter alerts.

U.S. Pat. No. 6,604,130, Donoho shows a system where information can be brought to the attention of the consumer precisely when it has become applicable. In a typical mode of operation, a piece of advice may enter the consumer computer and remain resident for an extended period of time before becoming relevant information is displayed when it has become applicable, not before it does. Donoho does not disclose dispatching messages to a remote device for immediate sound or vibration alert upon arrival at the remote device.

U.S. Pat. No. 6,532,489, Merchant shows e-mail server does not alert the logged off user of every received e-mail message, but only of e-mail messages received that match some specified “importance” criteria or profile, such as e-mail messages received with a specified subject line, sender address, or sender handle. The user may specify, for example, as part of the alerting means connection information, a list of e-mail addresses or handles that signify “important” email message senders. Whenever one of these e-mail messages is received, the user is alerted of receipt of an e-mail message. Merchant provides no sequence of alerts that are close in time. Nor does Merchant provide for delayed transmittal of alerts.

U.S. Pat. No. 6,513,026, Horvitz, measures a cost of disruption. This is the cost of disrupting the user to convey the notification—for example, the user may be busy in a meeting, such that disrupting the user with a notification results in a cost to the user. Comparisons are made with the expected value of the information. Horvitz does not signal the quality of the message by selecting a time for delivery.

Enhanced Messaging Service (EMS) is a cross-industry collaboration between handset manufacturers and solutions developers, to embed simple multi-media inside SMS messages. EMS gives mobile phone users new ways to express feelings, moods and personality with as much ease as composing an SMS message. Media, including a ringtones, is stored in a User Data Header (UDH). The amount of information in each SMS is limited by the SMS standard. Thus, to include pictures and sound, the EMS message may be made up of a number of SMS messages. EMS does not specify storing of alerts for later delivery. EMS does not specify sending separate messages so as to repeat a ringtone.

U.S. Pat. No. 6,760,412, Loucks discloses a reminding technique that is used with the implementation of the scheduling program within an IP server which is to send an email message to an address specified by the user at the time indicated for the user to be reminded. The scheduling program, when an appointment requires a reminder to be sent, sends an email containing the text message reminder to among other things a voice telephone line. Loucks discloses attempts to dispatch reminders at a scheduled event. Loucks only provides for interposing a delay if the telephone for receiving a reminder is busy and unreachable, and provides for no establishment of delays such that a temporal notice is sent. Loucks scheduling program is responsive to events entered by a user though a user interface, and fails to disclose dispatching of alerts for reason of receiving a message.

### SUMMARY OF THE INVENTION

Temporal noticing may be the act and process of transmitting a discrete message, and, on the basis of tests that classify some input, e.g. an e-mail, rapidly transmitting at least a discrete message, or inhibiting the transmission of a discrete message by delaying their transmission based on a second and possibly unrelated input. It is the rigorous control of the timing between discrete messages that permits a user on the receiving end of a discrete message (sometimes called an alert) to perceive either an isolated alert from a thin client, such as a mobile phone, or perceive a train of alerts at the thin client.

Thus a method and apparatus is shown to transmit a notification alert by first receiving an electronic message having an associated destination or ‘to address’. The message is classified perhaps as high priority according to criteria of the user. Then a temporal notice is sent to the user carrying elements of the electronic message.

In addition a method is shown to receive a feed message, e.g. from an instant messaging source. The message is classified as first priority and thus deserves treatment by transmitting a pair of discrete messages with a small delay between the transmission. The messages carry collectively derivative data of the feed message.

A temporal notice may be more useful if the temporal notice, in the discrete message solitary form or in the discrete message plural form, carries some content with it so that the user is given some hint of what awaits if he should wish to take a detailed look at the initial input, which may be an e-mail.

### BRIEF DESCRIPTION OF THE DRAWINGS

These and other features, aspects, and advantages of the present invention will become more fully apparent from the following description, appended claims, and accompanying drawings in which:

FIG. 1A shows a likely place in a network that an embodiment would operate;

FIG. 1B shows another configuration of a network that would employ an embodiment;

FIG. 2 shows a time scale during an era during which an embodiment operates;

FIG. 3A shows a flow diagram of the embodiment that may provide routine handling of inputs;

FIG. 3B shows a flow diagram of the embodiment that may provide routine handling of inputs;

FIG. 4 shows an embodiment that chooses between routine handling or penalty box handling; and

FIG. 5 shows an embodiment server.

### DETAILED DESCRIPTION

Definitions:

Spam-inhibited wireless email address may comprise email addresses containing a domain registered with the FCC under the requirements of the CAN-SPAM act, as described in FCC press release of Aug. 4, 2002, titled “FCC TAKES ACTION TO PROTECT WIRELESS SUBSCRIBERS FROM SPAM”. Although the email addresses that mobile phones and other wireless devices are well known in the literature, the FCC provided: “The Commission adopted a general prohibition on sending commercial messages to any address referencing an Internet domain associated with wireless subscriber messaging services. To assist the senders of such messages in identifying those subscribers, the Commission required that commercial mobile radio service (CMRS) providers submit those domain names to the Commission for inclusion in a list that will be made publicly available”. The spam-inhibited wireless email addresses may also include email addresses that contain domains publicly listed by other governmental bodies as being domains for addresses typically allocated to wireless devices.

A telephone formatted email address may comprise an email address that contains at least ten digits, and may match a valid North American telephone number. A telephone formatted email address may also be an email address that contains sufficient digits to dial a telephone subscriber from another part of the world.

“To address” may mean an electronic email address that has at least five parts: an account number part, an ‘at’ symbol, a second-level domain, a period and a top-level domain, wherein such a string is placed following the string ‘To:’ (in email) or its equivalent.

“Noticeably prolonged delay” is a delay that is perceived by a typical user as much longer than a small delay. For example, if a short delay is 1 second, then a noticeably prolonged delay may be several seconds. If a short delay is 15 seconds, then a noticeably prolonged delay may be nearly twice that. In the context of temporal alerting, it is not helpful for an embodiment to operate with a small delay set to larger than 60 seconds. A noticeably prolonged delay may be about twice that time or longer. Note that it should be understood that a user, who is watching his watch, will notice considerably smaller durations between two different delays. The intention is to satisfy people who are more detached from their watches and can distinguish only much larger variations in delay. Since there are some people who cannot notice any variations in time, e.g. infants and people with disabilities, the meaning of “noticeably prolonged delay” is that delay which is detectable as a difference by the majority of the mainstream of users, or any longer delay. Since an embodiment will repeatedly use the same duration for a short delay and a largely unvarying noticeably prolonged delay, provided there is little variation in wireless infrastructure transmittal, the user experience of alerts will quickly reinforce to the user the usual and expected duration between alerts that arrive isolated, and alerts that arrive with about a short delay between them.

A user of an embodiment of the present invention has limited attention. During a day there is at least one period that a user is likely to not want messages intruding on his solitude. A typical such period is the time such a user uses to sleep at night, also known as sleep period. The remaining time or times during the day are known as awake period.

Since a user is likely to have a limited tolerance, even for important messages, it is wise to limit even the loud alerts that a user gets. For example, a malicious acquaintance of the user may decide to repeatedly message the user in a manner intended to vex the user. Consequently, the present invention envisions permitting the user to set a pre-set quota for each message type, or at least set a default pres-set quota in lieu thereof. Thus, various personal tastes of the user may be drawn from the user by, e.g. by HTML form that acts as a front end to a database storing user settings.

It is expected that a user will be present near a personal device having limited alerting capability of either a sound, light or vibration that may be addressed through the internet and other electronic means. Such a personal device may be able to receive a discrete message. As an example, a GSM mobile telephone may receive a 160 character message (and possibly a couple bits indicating presentation mode). A paging server, such as a SMSC (as commonly used in GSM systems) is an part of a paging service. The paging service is the collective devices that comprise the SMSC or other paging server, intervening infrastructure, and subscribing mobile devices. A message or transmittal directed at a SMSC, for example, may arrive in some form at a subscribing mobile to which the message is addressed.

In the context of the invention, to say a message is sent ‘to’ a device or service, means that the device or service may simply route, or effect a transition between protocols, and so to be ‘to’ a device or service means also to go via that device or service.

Now a user may subscribe to a number of feeds, each of which may or may not deliver a feed message to a subscriber (or user) during the day. A feed may include a Resource Description Framework Site Summary (RSS) feed or other news feeds as is known in the art. A feed may include electronic email (note its not uncommon for a user to have several email accounts). A feed may include a stream of instant messages. A feed may even include reports from a networked device and use raw data transmissions, e.g. User Datagram Protocol (UDP), sockets and the like.

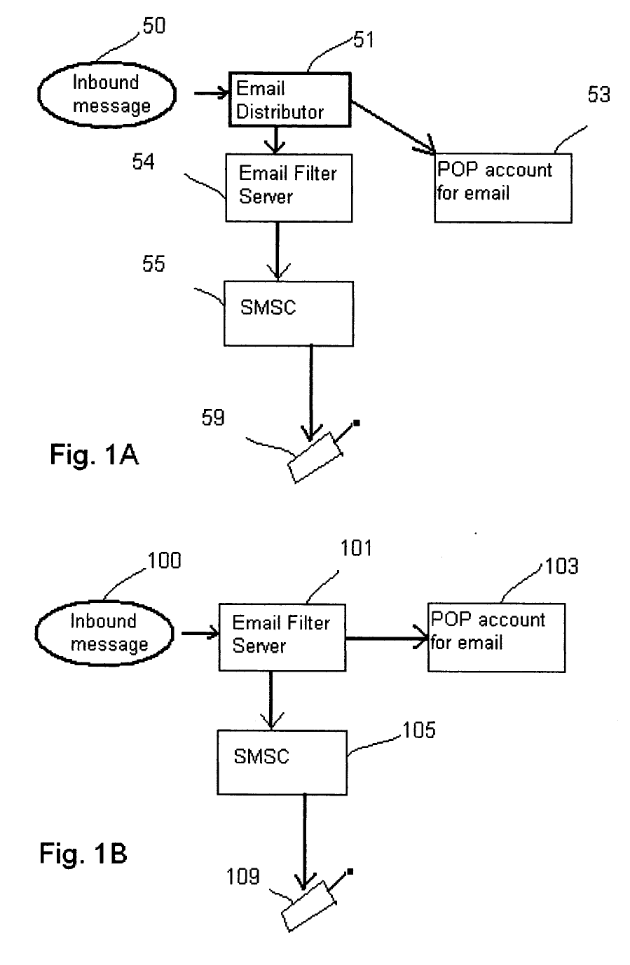

FIG. 1A shows an embodiment that receives an embodiment may receive messages from a POP or other mail server or distributor. An inbound message 50 arrives at email server 51 which provides temporary storage and possibly later downloading of email to a thick-client, which may be a conventional desktop computer 53. Email server 51 may forward a copy of the inbound message substantially unchanged to an embodiment email filter server 54. The embodiment email filter server 54 may detect the presence of strings or other indicia in an email that satisfies a user's pre-set criteria for dispatching an temporal notice to a thin-client 59 of the user's,

FIG. 1B shows an embodiment which may forward feed messages to a thin client. A thin client may be a device owned by a user. It includes, among other device types, pagers and telephones. A message 100, e.g. an email, may arrive to a feed filter server 101. The filter may provide a facility to forward elements or derivative parts of a feed message to two or more alternate facilities. One such facility may be a conventional feed server such as a Post Office Protocol (POP) account for email 103, though instant messaging and other clients of limited size or functionality may alternatively be used. This aspect would truly be at the discretion of the user, as the user may have a wide selection of devices upon which to receive a discrete message. One class of personal device may be a pager device. A pager device includes numeric pagers (used to send numbers and symbols of a conventional telephone keypad), and alphanumeric pagers, such as digital phones having a paging capability. At core, a pager device is a device that is unable to receive over 500 characters (or its data equivalent) in a single transmittal or packet. Thus an SMS compliant device would qualify since each transport layer transmittal is 160 characters or less. It may even be, at times, that the user prefers yet another email account (or responsive to email) account to receive a discrete message.

Thus, for the purposes of the embodiment, a user account is all settings made by a user that applies to a single personal device. Discussion herein concerning a quota, an awake time, a delay flag, a delay, a thin service client address, thick service client address and an era will then pertain to the signal personal device that a user has set up a user account for. An embodiment, by serving multiple users (or a user with multiple personal devices) may have several data structures—each for establishing and changing such data types applicable for each personal device.

Thus according to an embodiment, a paging server, such as a Short Message Service Center (SMSC) 105 may be a routing device for discrete messages transmitted from feed filter server 101. The connection from feed filter server 101 to SMSC 105 may be a direct connection without intermediary devices. If, however, the connection is via a network (internet), then security may be enhanced by using a tunneling protocol. Such a tunneling protocol may enable the SMSC to better authenticate the source of the message as the feed filter server 101, and improve the SMSCs ability to screen out unprocessed spam. Though not a requirement, the discrete messages produced by feed filter server, may be compliant with electronic mail standards. See Request For Comments (RFC) 821, RFC 822, RFC 934, RFC 937, RFC 974, RFC 976, RFC 1034, RFC 1035 and RFC 1123 for more details.

Nevertheless, because an SMSC 105 may truncate alphanumeric strings in the ‘subject’ and ‘body’ of an email (where such parts are beyond a certain length). The format of the message from feed filter server 101 to SMSC 105 is not important. What is significant for this embodiment is that the operation of the SMSC, or alternatives such as pager networks or wireless LAN (e.g. IEEE 802.11 wi-fi) converts from one protocol to another, wherein some elements of the original message may be discarded.

In other words, the feed filter server 101 may derive data from the input message 100 by a process of extracting derivative data. Such a process, may determine if the content of an email is likely to overrun the limitations of a typical SMSC 105 to transmit the contents within a single client discrete message (in the case of an SMSC, an SMS). Thus the discrete message may be abbreviated, or may be left largely in the same form as the input message (perhaps adjusting only the ‘to address’)—either way, the feed filter server 101 extracts derivative data.

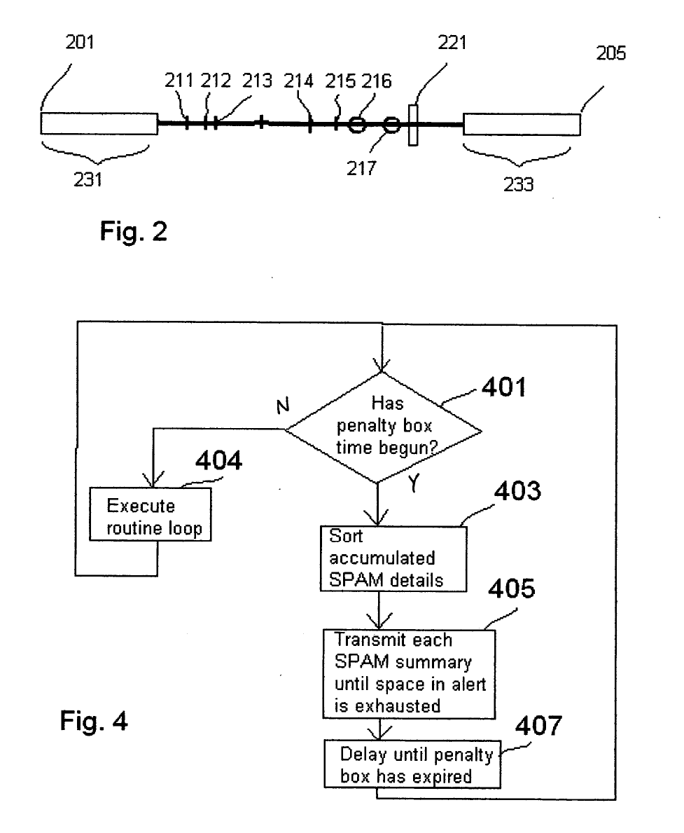

FIG. 2 is a time-line showing earliest times to the left. It shows an embodiment operating to dispatch both user-low-priority alerts, and a collective user-lowest-priority alert. The figure shows a time line during an era, in this case a typical day beginning with a midnight 201 starting the day and ending with a midnight 203 ending the day. The user experience may be such that the user has previously set a threshold to receive a maximum of five user-low-priority alerts, also known as a pre-set quota for that class of messages. A user-low-priority alert may be a single discrete message sent, followed by a prolonged delay during which the embodiment suppresses further alerts. The prolonged delay may be up to a minute duration, and is set in advance. Messages of user-low-priority up to five are indicated as alerts at various times during the day, and typically dispatched as discrete message virtually immediately upon receipt at a feed filter embodiment. A first electronic message 211, a second electronic message 212 a third electronic message 213, a fourth electronic message 214, and a fifth electronic message 215 are received. Subsequent feed messages, e.g. email, that match a user-low-priority criteria may be stored, at least in part, for later handling. Feed messages that match a SPAM criteria, using methods known in the art, may also be stored for later handling. A penalty box period 221 denotes the time at which a user has agreed to accept the handled SPAM, and other messages that were not handled reasonably immediately earlier in the day.

Messages that exceeded the pre-set quota for the era (in this case a day) appear as arrived sixth message 216, and arrived seventh message 217, and may be stored for later dispatch in a summary form.

During the penalty box period 221, a sorting algorithm may be used to identify which among the SPAM and other messages are able to be summarized in an alert. The penalty box is essentially a window in which a user expects alerts concerning these messages to arrive on her alerting device. A user hopes that SPAM and other message of low interest occur infrequently, and hopefully not at all. So the algorithm may have no such messages with which to send alerts. Consequently the penalty box is silent on that day.

Because, to a user, an alert arriving during the penalty box period has a particular connotation, care must be taken to briefly delay dispatching a discrete message concerning feed messages of user-low-priority and user-high-priority if it appears that the dispatch will cause an alert during this time at the remote device. By so doing, a user may hear alerts and briefly glance at her watch to confirm that the alert is of perhaps the lowest interest to her for reason that it is likely a feed message of the spam variety triggered the alert's timely delivery at that isolated time of day.

The possible congestion, and delays in network delivery may make accurate timing of delivery challenging. A penalty box duration of about ten minutes should be adequate to handle most such delays. Note that a broader penalty box will reduce ambiguity if the user tends to mark time with a poorly synchronized watch. Periods of sleep may be in the early morning 231, and the late night 233.

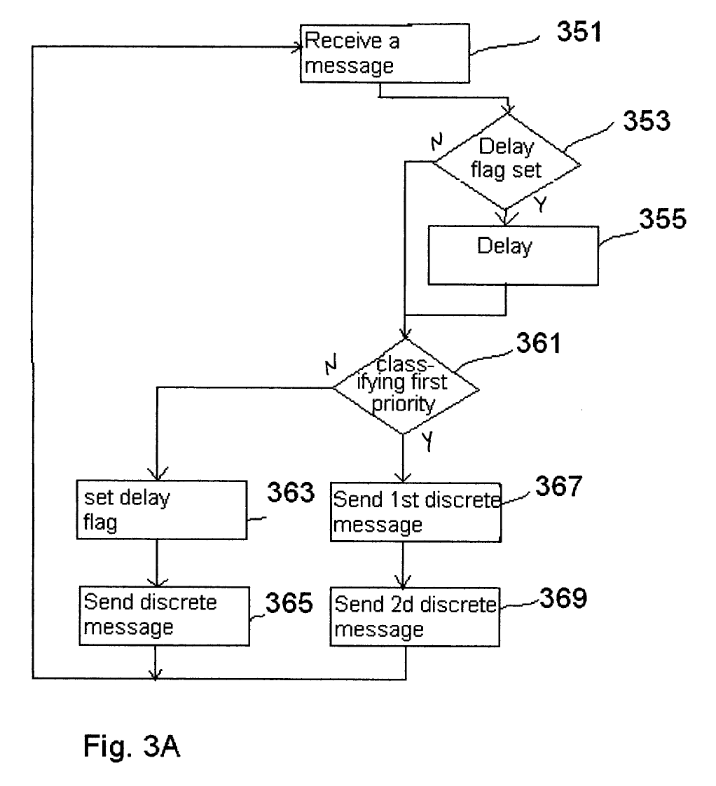

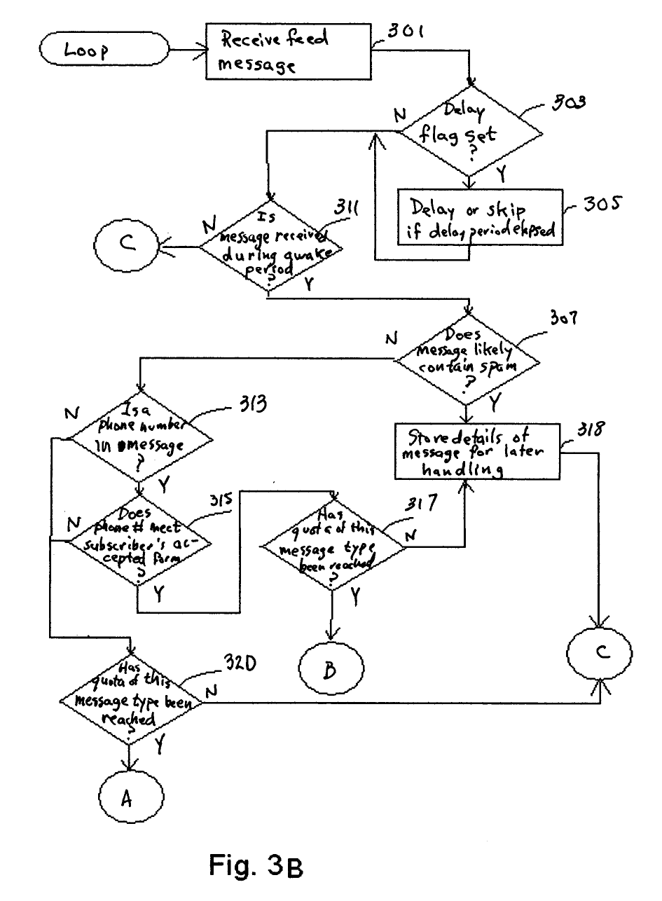

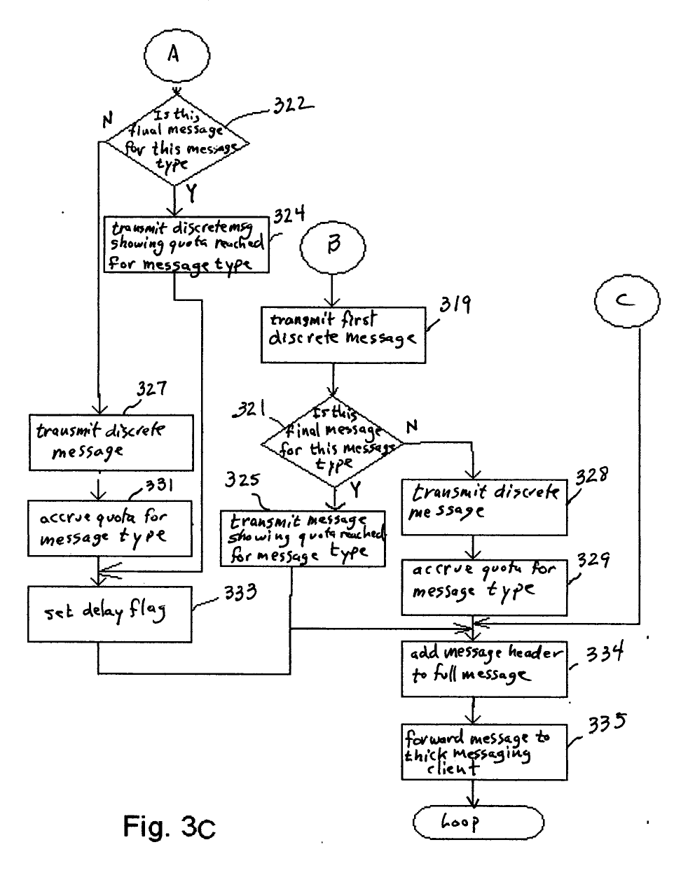

FIG. 3A shows a generalized embodiment. The embodiment may receive a feed message 351 and operates a delay 355 in case a delay flag was earlier set 353. The delay flag may be reset after the appropriate delay runs. The receiving step obtains the address that the message is directed to, and may look up a thin client service address that corresponds to that address, e.g. a pager number, and a correspondent delay flag that applies to that pager number (in some senses the pager number could be the key to a data structure). A classifying or sorting 361 of the message may occur classifying the message into one of at least two distinct groups or classes. If the message is classified a first priority feed message, then a delay flag may be set 363 such that, under most network operating conditions, the delay may impound a subsequent message by a time noticeably prolonged by the user whom is likely to be in the vicinity of the receiving device. The delay flag exists for each user account (perhaps indexed by, e.g. a pager number). Before or after the delay flag is set, a discrete message may be sent 365 which may contain elements of the message. If the message is classified a second priority feed message, then a first discrete message 367 may be sent, and forthwith, a follow-up discrete message may be dispatched 369 such that under most network operating conditions, the delay is noticeably small by the user as compared to the alerting first priority feed message. By sending a first discrete message and a follow-up discrete message during a shorter period, a user (recipient) may get notified, sometimes audibly, even some distance from the device that classification the message received. Each discrete message may be dispatched using a thin client service address that corresponds to the address-that-the-message-is-directed-to. Such an address may be earlier set by the user and looked up as part of receives-a-message 351 step, or perhaps derived from the ‘to address’.

Because the receiving device may be limited in the number of characters it may receive in a discrete message—the so called device limit—and the feed message itself may have contents larger than that character limit, one way to establish each of the discrete messages sent, is to split the larger feed message into at least two parts. One way could be, in the case of class second priority feed message (which may be an email), to dispatch just the subject of the message as a first discrete message, and then as many characters of the body in a follow-up discrete message. Alternatively, the body of a message could be transmitted in each of the discrete messages as two or more contiguous tracts of characters from the body of the original email. Yet another way would be to discard, abbreviate and compress words and transmit as much of the original email body as possible in the two or more discrete messages. Still yet another way, would be to send some number of characters from the original mail—smaller than the device limit—in a discrete message, and reserve a portion of the discrete message for brief sponsorship message, e.g. an advertisement or other independent message source. And still yet another way, would be in the event that the email message body is smaller than a discrete message, placing the body in one of the at least two discrete messages, and placing an empty message, or free-form set of text in the second of at least two discrete messages.

In each of the foregoing scenarios, at least one discrete message carries a derivative form of the original email, in the hopes that it may hint and be helpful to the user/recipient. Thus the one or some of the discrete messages may carry derivative data from the email feed message.

It should be noted that the delay 355 may merely be a set time increment after the time of dispatching a discrete message applicable to an earlier feed message. For example, if it is desired that all first priority feed messages receive a delay or impound period of 30 seconds following each dispatched alert, and the latest dispatched electronic message was at 10:00:00 AM, then the delay is expired at 10:00:30 AM, and a message received at 10:01:00 AM may cause the embodiment to enter the delay 355, and noting that the time is already expired, such delay step 355, may immediately move execution to the next process step, classifying or sorting 361. Had the current feed message arrived at 10:00:09 AM, the delay step would have held up processing, in effect impounding the current message, for another 21 seconds.

The user, receives second priority feed message, with a penalty—one that doesn't occur with conventional emails. The penalty is that the receipt of a second electronic message often gets saved in a distinct part of memory on the user's device, and consequently, when a user cleans out a folder of received messages, he has to delete at least two alerts (the received representation of a discrete message) instead of the conventional one. Thus to be of benefit to most users, the utility of the embodiment must be able to sort messages in such a consistent way, that the extra burden on the user is tolerable, when the supposed high-value message is classified as second priority feed message. Receiving a several alerts as a result of the embodiment processing a single message could be highly beneficial to a user if the user elects to use a classification step 361 that involves giving a positive test result if the sender is among a user's preferred senders, sometimes called a white list. Matching a message source against a white list is known in the art. Nevertheless, the embodiment contemplates a wide range of tests or classifiers. In essence, it is up to the user to establish a test to suit his tastes or set broad parameters for a classifier to work through. The embodiment signals the results of such user choices as related to inbound feed messages.

Collectively, the steps of setting a delay flag, receiving a second feed message having the applicable delay flag and during the pendency of such delay, running out the delay time prior to sending a discrete message derivative from the feed message is an example of impounding the second feed message. Another example of impounding is the mere steps of detecting that a delay flag is set, and continuing processing after determining that the delay period has already run.

FIG. 3B shows an embodiment operation of a feed filter server. A process may be started which continually receives or polls for feed messages (which may enqueue under some circumstances). This may be implemented by program control executing a loop. Upon receiving a feed message 301, a few checks may help to determine if the message is converted to a discrete message. Because the message may result in one, two in quick succession, or a train of discrete messages, there may be a delay imposed in process here. The sending of an earlier message may set a delay flag which may be detected 303, and then acted upon by setting a timeout or implementing some other delay 305 in program execution as is known in the art. The delay period is selected based on prior experiences with typical networks used to convey the discrete messages. In essence, if such networks convey a discrete message (similar to the type made by this invention) with a delay of ten seconds plus or minus an error of five seconds some 90% of the time, then a train of discrete messages could take 5 to 15 seconds inter-arrival time. It is the upper bound that is taken into account when setting a prolonged delay. That plus some nominal period that a user can be expected to sense through his innate time sense, would be the period to prolonged delay. In other words, in the example stated, it is likely that a user would consider two alerts occurring on his pager within 15 seconds to be of one type of priority, while a pair of alerts occurring 25 seconds apart to be alerts for two independently arriving feed messages.

Delay is accomplished in the event that a second feed message arrives but is so late as to not be a factor, i.e. the second feed message arrives after the delay period has elapsed. Though nothing more may be required in delay 305 than to reset the delay flag, that step still suffices to denote a delay. There are other methods known in the art to accomplish delay including timeouts. It is sufficient to track such timeouts and flags for the step of delaying to have occurred.

It is believed that because of the statistical variation in network operations, some discrete messages may be delayed by hours, and some delivered not at all. However this invention does not concern itself with those cases. Unfortunately, such vagaries of networks outside of the invention will alter the user experience adversely. Suffice it, that networks that are timely in delivery of alerts will permit a user to discern between a temporal notice comprising a single discrete message dispatched with a following quiet period, and the alternative temporal notice of at least two discrete messages dispatched close in time with each other.

In order to determine if the message is suitable for an intrusive discrete message, a check may be made to see if the message is arriving at a typical awake time for the user 311. There may be multiple periods that a user is not available that are tested at this point (for example, a time when a user is scheduled to swim, or shower or be driving). If the message does pass as arriving at an awake period, then a series of detailed tests 307 may occur using means known in the art such as Bayesian filtering to assign a likelihood that the message is of an unwanted type, typically known as SPAM. Often, an accumulation of indicia from the message are added to a spam-metric. If the spam-metric surpasses a certain threshold, a SPAM is indicated, and affirmative test occurs at test 307. SPAM is often in the eye of the beholder, and adjustments to the threshold may admit more spam through a negative test 307 test result. Regardless of the user's perception of the message, if test 307 negates the likelihood of SPAM, the message is processed further to screen for desired indicia, in this case the presence of a phone number 313 which may be tested with a regular expression as is known in the art. Presence of a phone number may cause processing to pass to ascertain if the phone number meet a form acceptable to the user 315, which may be a regular expression test.

A user may have set a number of desirable ranges or a telephone number property that determine if a user would like to get a rapid alert (via a discrete message). For example, a user may prefer only numbers in a home area code. Such telephone numbers may be tested with regular expressions as is known in the art 315 and may permit detection of telephone numbers even though parenthesis, dashes, dots, spaces and other separators are used. Messages that pass this test may be first priority feed messages, which is a type of feed message that is classified according to 313 and 315.

Note that the operation of tests such as 307, 313 and 315 may alone, or together operate to set an urgency metric for the received message. At heart, the urgency metric classifies a message into one of at least two levels. Finer gradations of measurement of interest by the recipient may be delivered via well known filters such as SpamAssassin.

It is believed that email contents having valid acquaintance phone numbers comprise minority of messages. As such, these type of messages, a species of user-high-priority, deserve greater attention. Affirmatively meeting the user's criteria in phone number test 315 may trigger a test that throttles back messages 320 if far too many arrive. Test 320 may hold messages that exceed a low-priority message pre-set quota, a negative test result, by not dispatching a discrete message. An era may be established according to a user's attention level to extend to a time on the order of a day. This era may have a limitation established through a pre-set quota. In lieu of a user's selection of a daily pre-set quota, it is believed that about five messages of this first priority type may be tolerable.

Providing the pre-set quota for high-priority messages is not yet reached 317, the message triggers a temporal notice by providing either a single discrete message followed by a quiet period of significant duration, or at least two discrete messages separated by a quiet period of insignificant duration. A temporally significant notice may be the transmittal of at least two discrete messages with little delay between each discrete message. Thus a first discrete message 319 may be dispatched to, e.g. the SMSC of FIG. 1. This step may be accompanied by incrementing the quota count for the current era. The step of transmitting a single discrete message may include looking up or identifying a thin client service address that corresponds with the ‘to address’ of an inbound email that may be the a feed message. The thin client service address may be a pager number, or perhaps a more amenable email address that a wireless carrier converts into a page. Thus it may be that an extraction of the input message is forwarded by identifing a thin service client address that corresponds with the to address.

Operation if the quota for the message type is reached 317 may continue processing by storing details of the message for later handling 318, perhaps vying with stored SPAM details for priority in dispatching news during a penalty box period.

Step 322 judges if this is the final message of the user-high-priority type pre-set quota for the era. If it is, some provision is given to the user within a second paired message transmittal 325. Otherwise, transmit a second discrete message 328. The second discrete message may contain at least one telephone number contained in the feed message. Continued accounting of the user-high-priority quota is kept by accruing an additional count to the message type 329. The act of transmitting a second discrete message 328 within a brief interval of transmitting the first discrete message 319 may generate a user experience known as a first priority alert.

Though not essential, an additional step may occur which further processes the message for review by a fuller message client or a large messaging client, e.g. one that is mediated by a POP mail account. If desired, message headers could be added 334 by means known in the art, to indicate the statistics concerning processing at the feed filter server. This step could accompany transmittal of the message to the large messaging client. Likely headers could include what the current quota count is.

A message that fails either the test of 1) presence of a telephone number in the message 313 or 2) presence of a telephone number that meets user's accepted form 315, may be classified as a user-low-priority type of message. Such a message may have a pre-set quota for user-low-priority type message, and a test 322 to determine if the email message of user-low-priority type has been received for the era 323. If so, the feed filter server may dispatch a discrete message derived from the message is transmitted showing the phrase “quota reached” 324 or the like. Otherwise (negative test outcome), the feed filter server will transmit a discrete message 327, followed by accruing another count of the quota for user-low-priority type 331. Since the feed message is intended to trigger an isolated discrete message so that it is not confused with a pairing of alerts at the remote device, a delay flag is set 333. The delay flag may set a timeout, or other timing mechanism to halt or delay processing so that any subsequent feed message received during the timeout also isolates the discrete message, if any, that the feed filter server transmits.

At the conclusion of sending zero, one or two discrete messages, the message may be forwarded to fuller message client 335. This step is optional in the case of the embodiment of Fig. 1B. The forwarding, or sending of the feed message is still regarded as sending the original message, despite the possibility that additional headers are added to the feed message (e.g. email) that show the intermediate nodes in its route and any additional email headers added to show disposition the email following operation of a spam filter. A second priority alert may include sending a first discrete message 327, along with a repose or pause of modest duration following dispatch.

FIG. 4 shows a loop of instructions which may operate to execute the routine loop shown in FIG. 3A or FIGS. 3B and 3C. The steps shown in FIG. 4 could be set to operate on a scheduled execution, however if it is preferred the instructions may be executed in a continuous loop that asks initially if the penalty box time has occurred 401. An affirmative result causes the accumulated details of email during either the current era, or from the time of last execution of the loop. A sorting 403 of accumulated spam and other messaging details follows. To the extent that space exists in a discrete message, the size of which may be preset according to the capabilities of the user device, the details, at least in summary, are added to the discrete message and transmitted 405 at least once. The penalty box may be preserved as sterile for a duration that may halt operation of the routine loop mentioned above. This may be accomplished by operating a further delay 407.

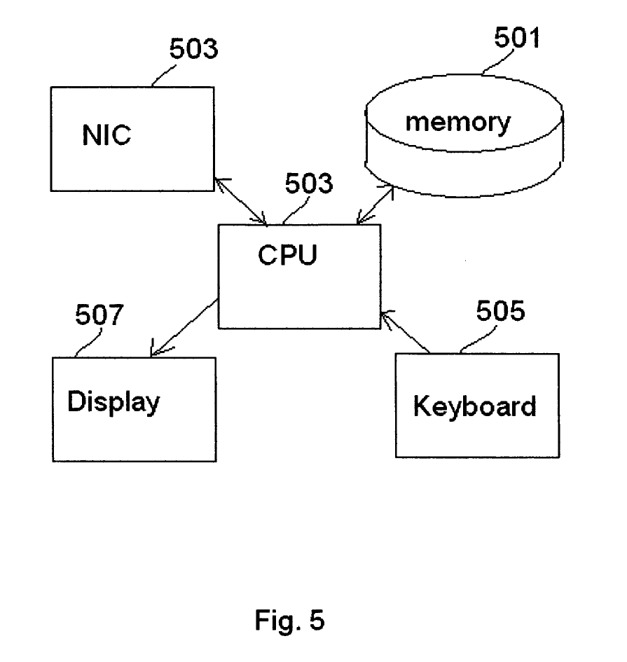

FIG. 5 shows an embodiment possessing a memory 501 which may store details of inbound messages and correspondence between to addresses and various user account data such as thin-client address, era, pre-set quotas applicable to the era for each message class, user selected criteria for sorting each class, current count for each pre-set quota during the current era and the like. Processor 503 may be a conventional central processing unit for executing program instructions, where such instructions, themselves, may be stored to memory 501. A network interface 505 may be provided to attach to various network devices including an SMSC or to the internet. The network interface may be addressed by various protocols such as SMTP, UDP, TCP/IP and others in support of networking functions. User interfaces such as at least one keyboard 507 and monitor 509 may be made available to update data structures stored in memory. Multiples of each component of the embodiment may be made available as standby units or load-sharing units in order to enhance robustness of running programs.

Temporal noticing then may be in three various classes. First, a message classified as SPAM may have details stored for handling. The user may have selected a time during the era when SPAM details may be delivered, which may be such things as the SPAM subject lines, or a truncated body of SPAM. This time is known as the penalty box. During a short interval before and a short interval following the penalty box, the routine loop process of FIG. 4 may be suspended (so messages are enqueued) so that an alert arriving is not confused to be among those other types of temporal notices. Thus, a user, upon hearing the result of a first temporal alert may merely look at her watch to see that the tone comes during the penalty box. At which point, she may feel it is safe to disregard the resultant tone, if for example, she were tied up with a hands-on task such as turning shish‘ka’bobs on a grill. Thus a first type of temporal alert may be impounding or withholding a class of alerts for actuation or transmittal during a recurring time of day.

A second type of temporal notice may be two or more discrete messages sent ( and most likely heard as two alerts) in quick succession. Such temporal notices, occurring in at least pairs, place a greater burden on the user to review and delete the messages—consequently, only messages of a higher order of interest to the user should be temporally noticed in that way.

The third type of temporal notice may be a single alert arriving at other than the penalty box time and isolated from other alerts transmitted by an embodiment by a time delay.

The second and third type of temporal notices are generally ad hoc and unsynchronized, while the first type of temporal notice is synchronized.

Though messages of a higher order of interest to the user should receive a second type of temporal notice, in the event that a pre-set quota of that type of message is exhausted during the era, then such a message may be deferred for handling as a SPAM having a low spam-metric. As such, details concerning the message(s) of a higher order of interest may be stored for later handling. Consequently, such a message may supersede messages classified as SPAM.

Thus the following algorithm may be invoked at penalty box time: 1) deliver as many details as practicable of the message(s) of higher order of interest (first in/first-out); 2) if space remains in an alert to carry deferred third type messages, carry the third type message details to the extent possible; 3) if space still remains in an alert to carry the SPAM classified message details, carry SPAM in the order of lowest spam-metric to highest; and 4) delete all spam-details and other message details that are left over when alert space is exhausted.

The space available in an alert is merely the limits of space for transmitting a single packet data. In the SMS based paging systems, the space typically is 160 characters, of which a few are allocated to carry information of the ‘from’ and ‘subject’ details.

Since a user may start, end, and transition to new pagers or other thin clients, particularly as a service contract ends, it may be helpful if the user has a facility connected with the feed filter server 101 to select a new such device or address to act as a host recipient of temporal notices and alerts. Again, an HTML form front-end could operate to collect such data from a user, as is known in the art. Alternatively, a user may be offered the possibility to forward messages from the old thin-client service to a new message recipient address. For example, a user could designate an email address proxy for his mobile phone paging service such as 8175551212@mobile.att.net, which is well known to be associated with at thin clients such as mobile telephones. The user, may later, under new laws that permit number portability, obtain new wireless service with another wireless carrier. In the process, a user may seek, and obtain email forwarding from the old carrier, in this example, AT&T® Wireless. However, during the interval while shopping for new service, or adjusting for a switch in the voice routing, the user may designate 8175551212@yahoo.com, a service better known for handling thick clients with POP email accounts. Later, the user may obtain service through another popular carrier, T-mobile. A user may seek, and obtain, from the hypothetical first carrier, forwarding to still another address. This time it could be 8175551212@t-mobile.com.

It will be appreciated that users may have varying interests, and so may choose to filter on other criteria than presence of telephone numbers. Perhaps a user is looking for critical pricing data from a monthly report given by email, and the sender's address is well known to the user. Under such a circumstance the address may be the distinguishing factor, and will suffice to classify email into a user-high-priority. Thus the present invention is not limited by the variety of filtering taking place.

Similarly, a user may take a particularly high interest in messages that either carry an attached vCard or vCalendar entry. In such a case, the filter, or sorting step may be one that assigns the second alert priority to such messages as hold the standard compliant vCard or vCalendar in the message. The formats for such attachments are well known in the art. To test for the presence of a vCard or vCalendar, a regular expression may be used that tests for the minimal indicia of such data, e.g. such text as the begin vcard delimiter or a begin vcalendar delimiter, which are, respectively, the strings “begin:vcard” and “begin:vcalendar”.

As can be imagined, searching for the literal strings mentioned above does not guarantee that the text that follows meets vCard or vCalendar standards in all respects. Nevertheless, such indicia, if detected, can give a reasonable expectation that such data is contained in the email. Thus, constructing regular expressions that search for the strings mentioned or other strings required in a valid vCard or vCalendar may be used. As a class, such regular expressions or tests, are known as personal data interchange tests. Such tests generate a hit, or match, when a string is detected which reasonably can be expected to indicate a complete Internet Mail Consortium compliant data structure (and subsequent revisions) is present in the message.

Still another form of classification test may be to use a regular expression to find the presence of uniform resource locators, or text prefaced with a ‘www’ within the body of a feed message.

Also, the notion of an awake period, though nice, is unnecessary in the instance where a user routinely either a) turns off his alerting device; or b) in the case of a mobile telephone, opts to select a profile that causes alerts to be received silently.

The use of a paging server may include the use of the text messaging servers as used in the GSM, CDMA, iDen and successor wireless systems as proposed by 3GPP and 3GPP2, among others.

What is claimed is:

1. A method to transmit a notification alert to a thin messaging service comprising the steps of:
receiving an electronic message having at least a content and a to address;
classifying the electronic message; and
transmitting to a thin service client address a temporal notice having data derivative of the electronic message.

2. The method to transmit a notification alert of claim 1 wherein the step of transmitting to a thin service client address comprises:
identifying at least one thin service client address that corresponds with the to address.

3. The method to transmit a notification alert of claim 1 wherein the step of transmitting to a thin service client address comprises:
delaying for a noticeably prolonged delay;
transmitting to the thin service client address a second temporal notice.

4. The method to transmit a notification alert of claim 1 wherein the step of transmitting to a thin service client address further comprises:
transmitting a first discrete message having a first derivative data; and
transmitting a second alert having a second derivative data.

5. The method of claim 4 wherein the step of transmitting a second alert comprises: transmitting a second alert in a small delay after transmitting the first discrete message.

6. The method to transmit a notification alert of claim 5 wherein the step of transmitting a first discrete message comprises:
deriving derivative data from the electronic message;
identifying a thin service client address that corresponds with the to address; and
transmitting the derivative data to the thin client address.

7. The method to transmit a notification alert of claim 5 wherein the step of classifying comprises:
detecting a telephone number in the electronic message.

8. The method to transmit a notification alert of claim 5 wherein the step of classifying comprises detecting a telephone number meeting a user criterion.

9. The method to transmit a notification alert of claim 4 wherein the step of classifying comprises:
detecting a spam-metric below a threshold.

10. The method to transmit a notification alert of claim 4 wherein the step of classifying comprises:
detecting a urgency metric above a threshold.

11. The method to transmit a notification alert of claim 4 wherein the step of classifying comprises:
detecting indicia of a personal interchange data in the electronic message.

12. The method to transmit a notification alert of claim 1 further comprising the step of:
receiving a second electronic message having details;
accruing current-era quota to equal a pre-set quota of alerts;
storing details in memory;
operating on details during a user-specified penalty box.

13. The method of claim 1 to transmit a notification alert further comprising storing the electronic message to an email server.

14. the method of claim 13 further comprising adding a header to the electronic message.

15. the method of claim 14 wherein the step of classifying comprises:
classifying the electronic message as first priority.

16. the method of claim 15 wherein the step of storing further comprises inserting a header indicating first priority.

17. The method to transmit a notification alert of claim 1 wherein the step of classifying comprises:
classifying the electronic message as either high priority or low priority.

18. The method to transmit a notification alert of claim 17 wherein the step of transmitting comprises:
transmitting to a thin service client address a temporal notice comprising
sending a first discrete message and
sending a second discrete message shortly after sending the first discrete message, wherein the first discrete message is derivative of the electronic message and the second discrete message is derivative of the electronic message, provided the electronic message is classified as high priority.

19. The method of claim 18 wherein the step of transmitting further comprises:
identifying at least one thin service client address that corresponds with the to address.

20. The method of claim 19 wherein the step of identifying comprises:
identifying at least one spam-inhibited wireless email address that corresponds with the to address.

21. The method of claim 19 wherein the step of identifying comprises:
identifying at least one telephone formatted email address that corresponds with the to address.

22. A method to transmit an alert to a thin messaging service comprising the steps of:
receiving a feed message;
classifying the feed message as a first priority feed message;
transmitting a first discrete message;
transmitting a second discrete message within a small delay after transmitting the first discrete message;
wherein the first discrete message and the second discrete message transport data derivative of the feed message.

23. The method of claim 22 further comprising the steps of:
delaying for a noticeably prolonged delay;
transmitting a third discrete message.

24. The method of claim 23 wherein the step of transmitting a third discrete message comprises:
transmitting the third discrete message wherein the third discrete message transports data derivative of a second feed message.

25. The method of claim 23 wherein the small delay is under 8 seconds.

26. The method of claim 23 wherein the noticeably prolonged delay is over 8 seconds.

27. The method of claim 23 wherein the step of transmitting comprises:
transmitting a first discrete message to a thin messaging service.

28. The method of claim 23 wherein the step of transmitting comprises:
transmitting a first discrete message to/via a paging server.

29. The method of claim 23 further comprising the step of delaying a noticeably prolonged delay.

30. The method of claim 23 wherein the feed message has a to address and the step of transmitting a first discrete message comprises:
transmitting to an thin client address that corresponds with the to address.

31. The method of claim 30 wherein the feed message has a to address, and the step of transmitting a first discrete message comprises:
transmitting to at least one spam-inhibited wireless email address that corresponds with the to address.

32. The method of claim 30 wherein the step of transmitting comprises:
transmitting a first discrete message to a thin messaging service.

33. The method of claim 30 wherein the step of transmitting comprises:
transmitting a first discrete message to a paging server.

34. The method of claim 30 further comprising the step of:
delaying a noticeably prolonged delay.

35. The method of claim 32 wherein the step of classifying comprises the step of:
detecting a string containing a number.

36. The method of claim 35 wherein the step of classifying comprises the step of detecting a string containing a four digit number.

37. The method of claim 32 wherein the step of classifying comprises the step of detecting a string containing a uniform resource locator.

38. The method of claim 32 wherein the step of classifying comprises the step of detecting a string likely containing a telephone number.

39. The method of claim 38 wherein the step of classifying comprises detecting a telephone number falls within a range.

40. The method of claim 30 wherein the step of classifying comprises the step of:
detecting a from address among a list of at least one desired sender.

41. The method of claim 30 wherein the step of classifying comprises the step of:
detecting a desired string within a from address.

42. The method of claim 30 wherein the step of classifying comprises the step of:
detecting a desired string within a body.

43. An apparatus to transmit a notification alert to a thin messaging service comprising:
a network interface receiving an electronic message having at least a content and a to address;
a processor classifying the electronic message and said processor transmitting to a thin service client address a temporal notice having data derivative of the electronic message.

44. The apparatus to transmit a notification alert of claim 43 wherein the processor transmitting to a thin service client address further identifies at least one thin service client address that corresponds with the to address.

45. The apparatus to transmit a notification alert of claim 43 wherein the processor transmitting to a thin service client address comprises:
a processor for delaying for a noticeably prolonged delay after transmitting to a client address then said processor transmits to the thin service client address a second temporal notice.

46. The apparatus to transmit a notification alert of claim 43 wherein the processor transmitting to a thin service client address further comprises:
a processor for transmitting a first discrete message having a first derivative data; and
said processor transmitting a second alert having a second derivative data.

47. The apparatus of claim 46 wherein the processor for transmitting a second alert comprises:
a processor for transmitting a second alert a small delay after transmitting the first discrete message.

48. The apparatus to transmit a notification alert of claim 47 wherein the processor for transmitting a first discrete message comprises:
a processor for deriving derivative data from the electronic message;
a processor for identifying a thin service client address that corresponds with the to address; and
a processor for transmitting the derivative data to the thin client address.

49. The apparatus to transmit a notification alert of claim 47 wherein the processor for classifying comprises:
a processor for detecting a telephone number in the electronic message.

50. The apparatus to transmit a notification alert of claim 47 wherein the processor for classifying comprises a processor for detecting a telephone number meeting a user criterion.

51. The apparatus to transmit a notification alert of claim 48 wherein the processor classifying comprises:
a processor for detecting a urgency metric above a threshold.

52. The apparatus to transmit a notification alert of claim 43 further comprising:
a processor for receiving a second electronic message having details;
a processor for accruing current-era quota to equal a pre-set quota of alerts;
a processor for storing details in memory and operating on details during a user-specified penalty box.

53. A computer-readable storage medium containing a set of instructions for a processor having a network interface, said computer readable set of instructions comprising the steps:
receiving an electronic message having at least a content and a to address;
classifying the electronic message; and
transmitting to a thin service client address a temporal notice having data derivative of the electronic message.

54. The computer-readable storage medium of claim 53 wherein the instructions further comprising the steps:
identifying at least one thin service client address that corresponds with the to address.

55. The computer-readable storage medium of claim 53 wherein the instructions further comprising the steps:
delaying for a noticeably prolonged delay;
transmitting to the thin service client address a second temporal notice.

56. The computer-readable storage medium of claim 53 wherein the instructions further comprising the steps:
transmitting a first discrete message having a first derivative data; and
transmitting a second alert having a second derivative data.

57. The computer-readable storage medium of claim 56 wherein the instructions further comprising the step:
transmitting a second alert in a small delay after transmitting the first discrete message.

58. The computer-readable storage medium of claim 57 wherein the instructions further comprising the steps:
deriving derivative data from the electronic message;
identifying a thin service client address that corresponds with the to address; and
transmitting the derivative data to the thin client address.

59. The computer-readable storage medium of claim 57 wherein the instructions further comprising the step:
detecting a telephone number in the electronic message.

60. The computer-readable storage medium of claim 57 wherein the instructions further comprising the step detecting a telephone number meeting a user criterion.

61. The computer-readable storage medium of claim 56 wherein the instructions further comprising the step:
detecting a spam-metric below a threshold.

62. The computer-readable storage medium of claim 56 wherein the instructions further comprising the step:
detecting a urgency metric above a threshold.
